(19) United States
(12) Patent Application Publication
(10) Pub. No.: US 2016/0250698 A1
(43) Pub. Date: Sep. 1, 2016

(54) Bow Saw

(71) Applicant: HACK SAW & KNIFE MANUFACTORY CO., LTD., Taichung City (TW)

(72) Inventor: Tien-Yu Huang, TAICHUNG (TW)

(21) Appl. No.: 14/634,722

(22) Filed: Feb. 27, 2015

(51) Int. Cl. B23D 51/01; B23D 51/10

(52) U.S. Cl. CPC B23D 51/01; B23D 51/10

(57) ABSTRACT

A bow saw includes a support unit, a saw blade and an ergonomic grip. The support unit includes a bow and a handle connected to an end of the bow. Two ends of the saw blade are connected to two ends of the bow. The ergonomic grip is provided on the bow near another end of the bow.

### TOPGROUND OF INVENTION

1. Field of Invention

The present invention relates to a bow saw and, more particularly, to an ergonomic bow saw.

2. Related Prior Art

As disclosed in Taiwanese Patent No. 43428, a conventional hand saw includes a saw blade connected to a grip. To saw a work-piece, a user holds the grip with one hand or two to move the saw blade on the work-piece to and fro.

As disclosed in French Patent No. 2624780, a conventional bow saw includes a saw blade connected to a bow formed with a handle. The bow includes two ends each connected to a corresponding end of the saw blade. To saw a work-piece, a user holds the grip with one hand and holds the bow with the other hand to move the saw blade on the work-piece to and fro.

### SUMMARY OF INVENTION

It is the primary objective of the present invention to provide an ergonomic bow saw.

A bow saw includes a support unit, a saw blade and an ergonomic grip. The support unit includes a bow and a handle connected to an end of the bow. The saw blade is connected to the bow. The ergonomic grip is provided on the bow near another end of the bow.

Other objectives, advantages and features of the present invention will become apparent from the following description referring to the attached drawings.

### BRIEF DESCRIPTION OF DRAWINGS

The present invention will be described via detailed illustration of three embodiments referring to the drawings wherein:

FIG. 1 is a perspective view of a bow saw according to the first embodiment of the present invention;

FIG. 2 is a side view of the bow saw shown in FIG. 1;

FIG. 3 is a perspective view of an ergonomic grip of the bow hook of FIG. 1;

FIG. 4 is a cross-sectional view of the bow saw shown in FIG. 1;

FIG. 5 is a cross-sectional view of a bow saw according to the second embodiment of the present invention; and

FIG. 6 is a cross-sectional view of a bow saw according to the third embodiment of the present invention.

### DETAILED DESCRIPTION OF EMBODIMENTS

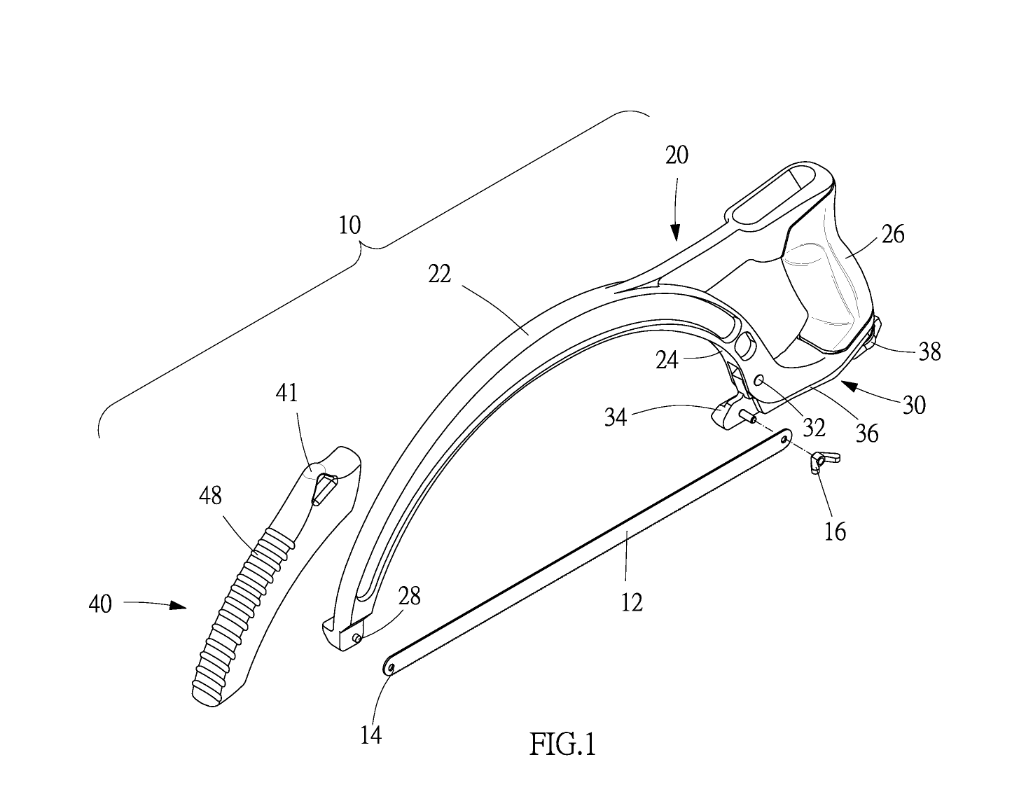

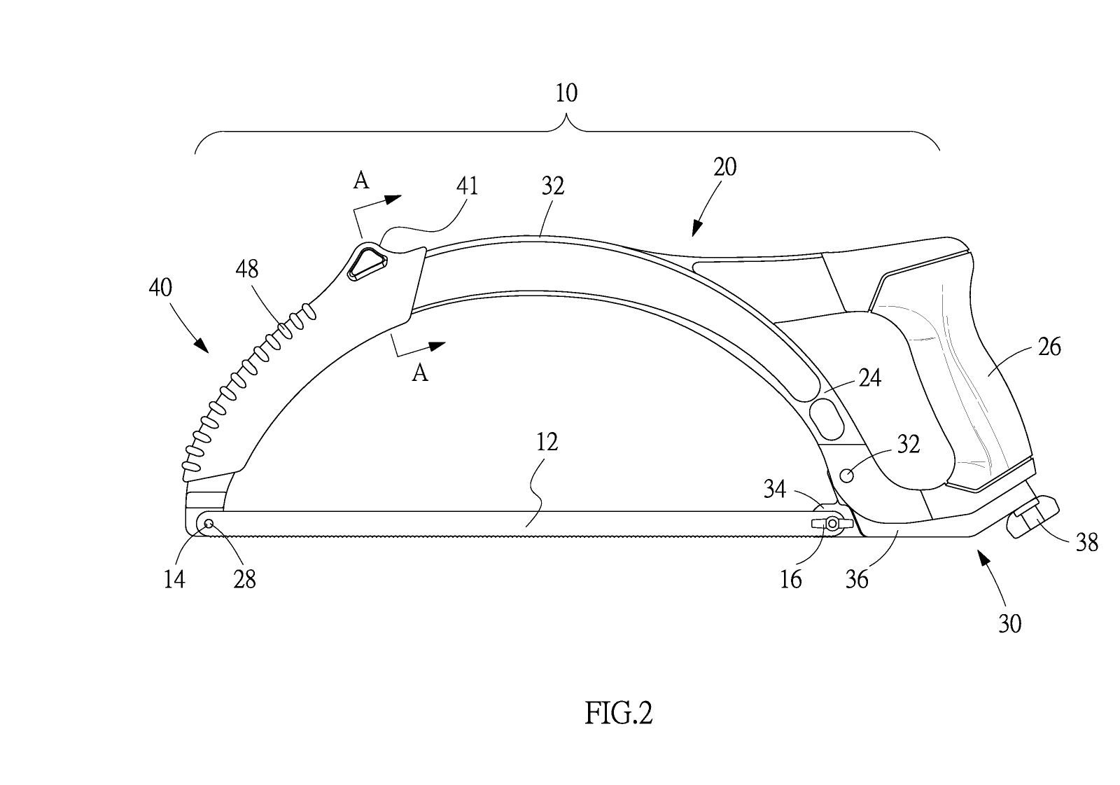

Referring to FIGS. 1 and 2, a bow saw 10 includes a saw blade 12, a support unit 20, a lever 30 and an ergonomic grip 40 according to a first embodiment of the present invention. The saw blade 12 is an elongated flat element with teeth formed at an edge. The saw blade 12 includes two apertures 14 each located near a corresponding end.

The support unit 20 includes a bow 22, a guard 24 and a handle 26. The guard 24 is formed at a first end of the bow 22. The guard 24 can however be omitted in another embodiment. The handle 26 is connected to the bow 22, in the vicinity of the guard 24. The rod 28 is formed on a side of the bow 22 near a second end.

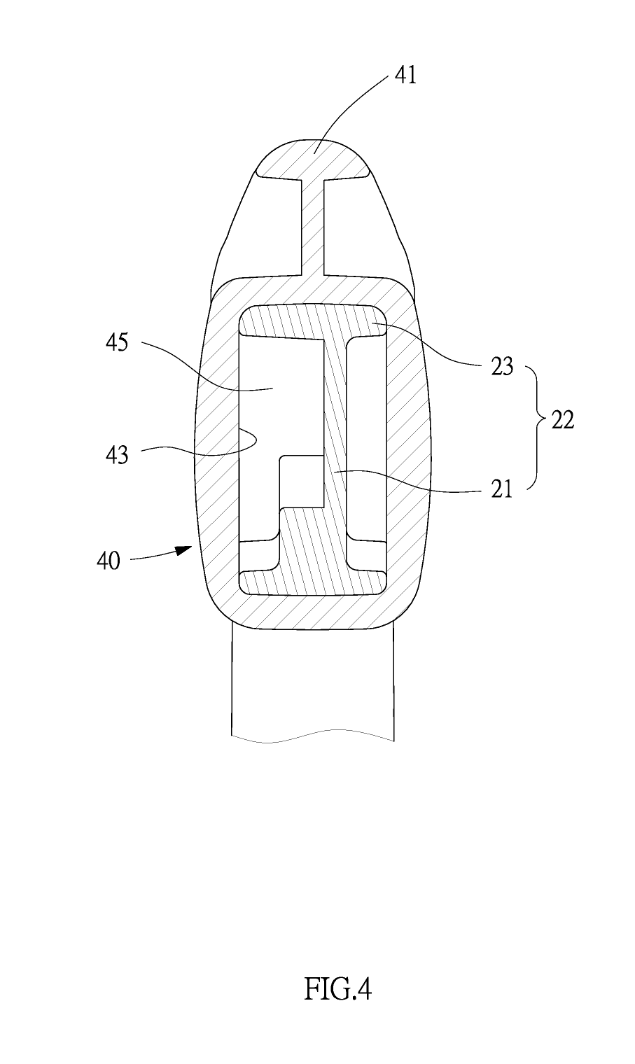

Referring to FIG. 4, the bow 22 is preferably made of iron. The bow 22 is in an I-shaped configuration that includes a fin 21 between two wings 23 as shown in a cross-sectional view. For convenience of the following description, one of the wings 23 is referred to as the upper wing 23 while the other wing 23 is referred to as the lower wing 23. Thus, the I-shaped configuration allows the bow 22 to be made with an adequate strength at a little weight.

The lever 30 includes two ends 34 and 36. A fastener 32 is used to pivotally connect the lever 30 to a portion of the support unit 20 between the guard 24 and the handle 26. An adjustor 38 is provided at the end 36 of the lever 30.

One of the ends of the saw blade 12 is connected to end 34 of the lever 30 by a fastener 16 that includes a threaded bolt and a butterfly nut. The lever 30 is pivoted between a locking position and a releasing position. When the lever 30 is located in the releasing position, the threaded bolt is inserted in one of the apertures 14 of the saw blade 12 before the threaded bolt is engaged with the butterfly nut. The rod 28 is inserted in the other aperture 14. The saw blade 12 is slack. Then, the lever 30 is pivoted to the locking position to render the saw blade 12 tight. The adjustor 38 is operable to adjust the tightness of the saw blade 12 by moving the fastener 16 toward or away from the rod 28.

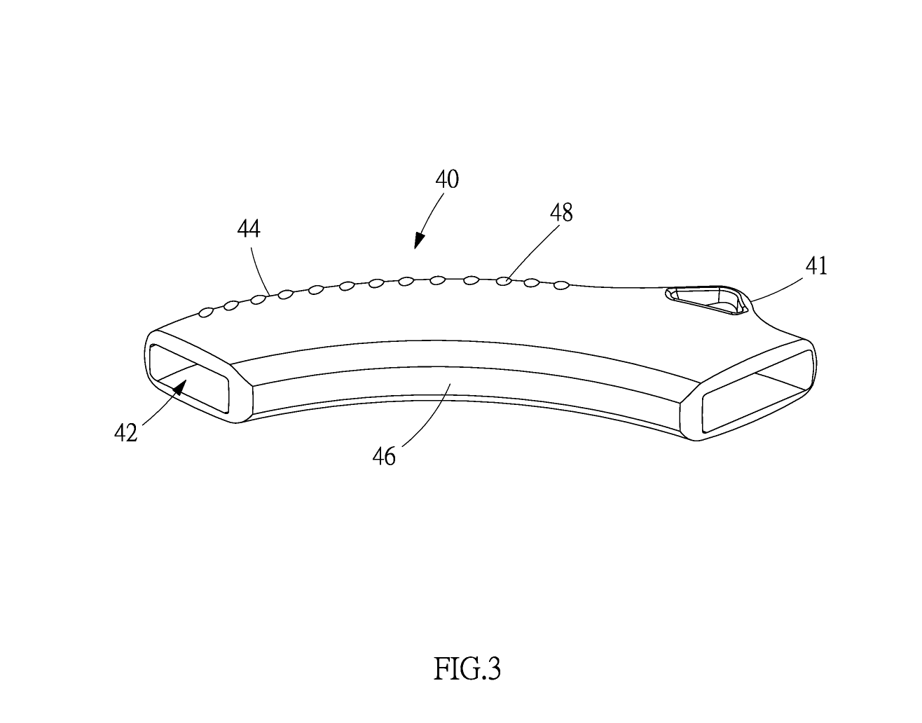

Referring to FIG. 3, the ergonomic grip 40 includes a thumb-contact portion 41, a channel 42, two lateral portions 43, a top 44, a bottom 46 and an anti-skid unit 48. The channel 42 is defined by the lateral portions 43, the top 44 and the bottom 46. The ergonomic grip 40 is an arched element. Both of the top 44 and bottom 46 extend in curves. The curvature of the top 44 is smaller than that of the bottom 46. The lateral portions 43 are formed between the top 44 and the bottom 46. The thumb-contact portion 41 is formed on the top 44. The thumb-contact portion 41 is a substantially triangular protrusion formed with a concave face for contact with a user's thumb. The anti-skid unit 48 is also formed on the top 44. The anti-skid unit 48 includes ribs. The anti-skid unit 48 can however include bosses in another embodiment. The entire ergonomic grip 40 is made of an elastic and soft material such as robber.

Referring to FIG. 4, the ergonomic grip 40 is provided the bow 22, near the second end of the bow 22. That is, a portion of the bow 22 near the second end is inserted in the ergonomic grip 40. Thus, a space 45 is defined by a lateral portion 43 of the ergonomic grip 40, a side of the fin 21, a half of the upper wing 23, and a half of the lower wing 23. Another space 45 is defined by another lateral portion of the ergonomic grip 40, another side of the fin 21, another half of the upper wing 23, and another half of the lower wing 23.

To saw a work-piece, a user holds the handle 26 with a hand (the “first hand”) and holds the ergonomic grip 40 with the other hand (the “second hand”) to move the saw blade 12 on the work-piece to and fro. The ergonomic grip 40 prevents a user's hand from directly pressing edges of the upper and lower wings 23 to provide a soft touch for the user's hand. The spaces 45 allow the lateral portions 43 to be pressed toward each other to provide a soft touch for the user's hand. The thumb of the second hand is in contact with the concave face of the thumb-contact portion 41 while the other fingers of the second hand are in contact with the anti-skid unit 48. Thus, the user has firm control over the bow saw 10.

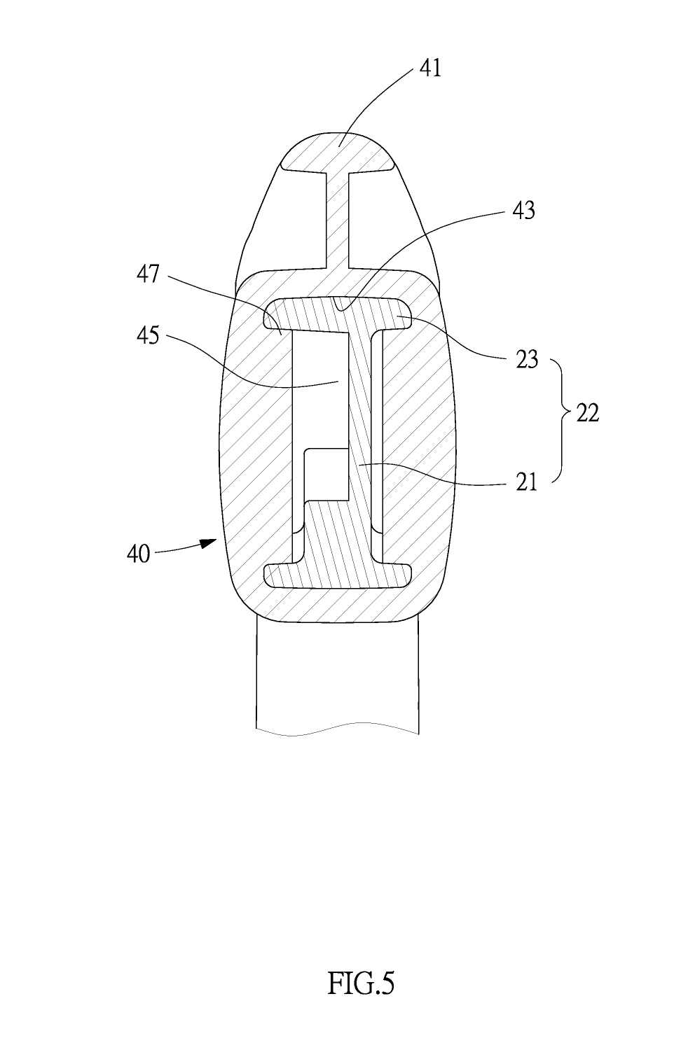

Referring to FIG. 5, there is shown a bow saw according to a second embodiment of the present invention. The second embodiment is identical to the first embodiment except that each of the thicker lateral portions 43 of the ergonomic grip 40 is made with a protrusion 47. The protrusions 47 are located in the spaces 45. Each of the edges of the upper wing 23 is sandwiched between the top 44 and a corresponding of the protrusions 47. Each of the edges of the lower wing 23 is sandwiched between the bottom 46 and a corresponding of the protrusions 47.

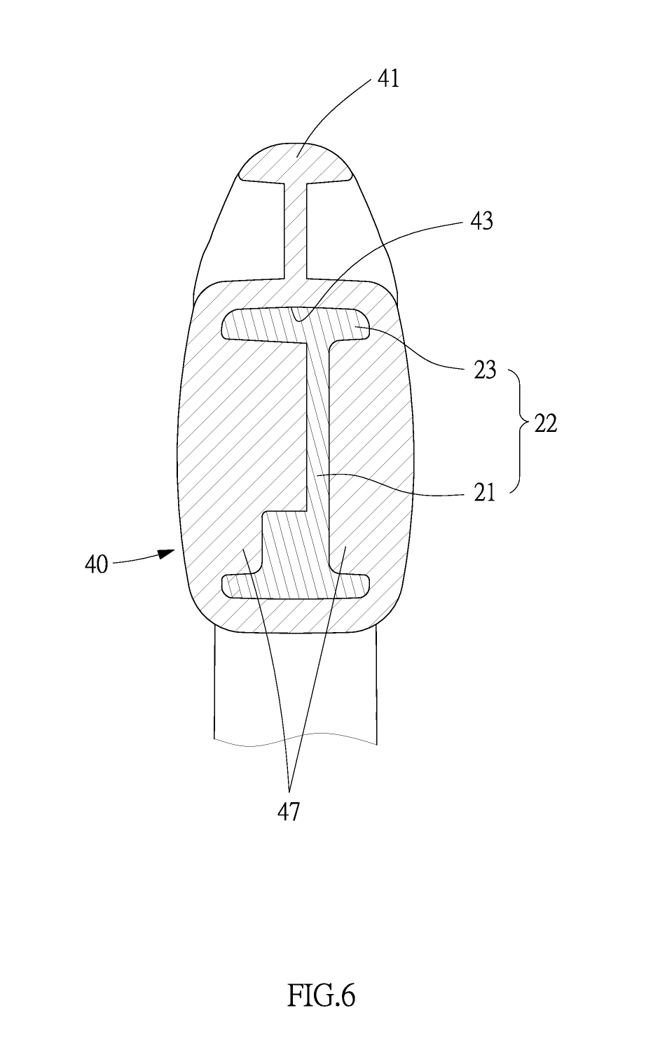

Referring to FIG. 6, there is a bow saw according to a third embodiment of the present invention. The third embodiment is identical to the second embodiment except that the protrusions 47 are made of larger thickness. Thus, the spaces 45 are completely occupied by the protrusions 47. The ergonomic grip 40 prevents a user's hand from directly pressing the edges of the upper and lower wings 23 to provide a soft touch for the user's hand.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A bow saw including:
a support unit including a bow and a handle connected to an end of the bow;
a saw blade connected to the bow; and
an ergonomic grip provided on the bow near another end of the bow.

2. The bow saw according to claim 1, wherein the ergonomic grip includes a channel for receiving a portion of the bow.

3. The bow saw according to claim 1, wherein the bow includes two wings and a fin formed between the wings, wherein the ergonomic grip includes two lateral portions so that a space is defined between each of the lateral portions of the ergonomic grip and a corresponding side of the fin.

4. The bow saw according to claim 3, wherein the ergonomic grip includes two protrusions each extending from a corresponding one of the lateral portions into a corresponding one of the spaces.

5. The bow saw according to claim 4, wherein each of the spaces is completely occupied by the corresponding protrusion.

6. The bow saw according to claim 1, wherein the top is made of a curvature smaller than that of the bottom.

7. The bow saw according to claim 1, wherein the ergonomic grip further includes a thumb-contact portion formed on the top and used for contact with a user's thumb.

8. The bow saw according to claim 7, wherein the thumb-contact portion of the ergonomic grip includes a protrusion formed on the top.

9. The bow saw according to claim 8, wherein the thumb-contact portion of the ergonomic grip includes a concave face for contact with the user's thumb.

10. The bow saw according to claim 7, wherein the ergonomic grip further includes an anti-skid unit for contact with the user's fingers except for the thumb.

11. The bow saw according to claim 9, wherein the anti-skid unit includes ribs.
